(19) United States
(12) Patent Application Publication
(10) Pub. No.: US 2005/0045710 A1
(43) Pub. Date: Mar. 3, 2005

(54) Amusement park system

(76) Inventor: Nicholas Burke, Norwalk, CT (US)

Correspondence Address: ANTHONY H. HANDAL;KIRKPATRICK & LOCKHART, LLP, 599 LEXINGTON AVENUE, 31ST FLOOR, NEW YORK, NY, 10022-6030, US

(21) Appl. No.: 10/722,969

(22) Filed: Nov. 26, 2003

Related U.S. Application Data
(60) Provisional application No. 60/456,437, filed on Mar. 24, 2003.

(51) Int. Cl. G06F 17/00

(52) U.S. Cl. 235/375

(57) ABSTRACT

An amusement park wireless transceiver associated with a guest account designator for a plurality of attraction facilities comprises a central computer, and a plurality of attraction facility computers. Each of the attraction facility computers is associated with one of the attraction facilities. A plurality of communication channels couple information in two directions between the central computer and the plurality of attraction facility computers, An input device is provided for receiving information indicating the number of persons in a group entering the amusement park and for assigning a guest account designator to each group, and for assigning an individual guest identification designator. A detectable marker unit is adapted to be physically associated with each guest and encoded with the guest's account designator. A wireless transceiver associated with the guest account designator communicates with the central computer to send and receive information.

### FIELD OF THE INVENTION

The invention relates to a method of enhancing fun and safety in an amusement park by accessing information on a database via a handheld device for patrons.

### BACKGROUND

Family outings are occasions that can be wonderful times for bonding and spending quality time together. Family outings to amusement and theme parks can be special times that leave children with lifelong memories of “meeting” their favorite cartoon character or having their own “real-life” action adventure.

Such outings can also be sources of stress and concern for family members visiting an area with so many new sights and sounds. It is easy for both adults and children to become distracted by all the excitement and attractions. Often attempts to plan the trip and including the children in that process will help make your outing in the park more enjoyable and safe can be quite involved, not anticipate all possible mishaps, and fail due to numerous causes.

There are many problems common to amusement parks. One of the more serious problems is children getting separated from their parents. There are many precautions that can be taken to reduce the risk of losing a child or getting separated from your group. A number of amusement park facilities have tried to remedy this problem. There have been some successful plans implemented in some amusement parks across the country.

Valleyfair Amusement Park, for example, has instituted a new KidTrack program. This program assists in reuniting lost children with their parents. Parents can register their children for the safety system once they have entered the park. The children wear a special wristband with the parent's cell phone number on it. If the child becomes separated from their parents all they have to do is talk to any park employee for help.

ParkWatch is another new technology where for $2 to $3 a day, each child is given a wristwatch-like unit and parents can check kiosks around the park to find their whereabouts. Each wristband has a serial number and is programmed with the individual's name. ParkWatch has been installed at Hyland Water Park near Denver. Problems associated with amusement parks are of great concern and above given rise to much technology. See, for example, U.S. Pat. No. 6,606,556 Curatolo et al, U.S. Pat. No. 6,472,976 Wohl, U.S. Pat. No. 6,424,264 Giraldin, and U.S. Pat. No. 6,239,700 Hoffman et al.

### SUMMARY OF THE INVENTION

The present invention is a new method of tracking people within an amusement park. The goal of the invention is to increase the enjoyment and safety of the guests in the park. The invention centers around a multi-functional electric handheld device and a device monitoring backbone that will bring a multitude of services to park guests to allow them to access a range of services which fund operation of the system by freeing up patron time and reducing traffic, confusion and stress to allow increased activity levels. The system may also accommodate a rental fee for handheld devices, or the use of existing devices such as patron owned palm pilot (tm) or Blackberry (tm) devices. In accordance with the invention, when park guests purchases a ticket, they are outfitted with a wristbands. Within the wristband is a small transponder. The transponder allows the wireless data infrastructure to locate transponders and then all guests throughout the park. Each group of guests is provided with a single (or alternatively more than one, perhaps for a fee) transceiver. When the wristbands are distributed, they are assigned to the group transceiver. A user can determine and change a prepaid amount to be credited to the transceiver. The predetermined amount of funds assigned to the transceiver can then be transferred to the individual transponders.

The invention embodies a new tracking method designed to be used in amusement parks. When entry tickets are purchased, the family is fitted with a wristband and a handheld transceiver, which may be a dedicated device or a programmed consumer owned general purpose wireless device, such as a Blackberry (tm) or cellphone. Alternatively, wrist bands alone may be given out and the transceivers made an optional “extra”. The family is assigned to an account to which they can link a credit card in order to make in-park purchases. In addition the handheld device can display a map of the park giving the location of group members and highlighting points of interest, such as rides, restaurants, stores and other facilities. Because each person on the account has a wristband, the system can be used as a tracking device, and as a mechanism for charging the prepaid fund deposit.

Parents separated from their children is a common problem in amusement parks. This invention thus aids in reducing the number of children that get lost. The transceiver is configured to interrogate a central data base and display wait times for particular rides and attractions. If a user selects the option on the handheld device, the user is able to see the approximate wait time for a variety of information, including information obtained from park vendors, who are also connected to the backbone, for example, a particular park ride.

The device also includes a feature that allows the user to reserve a table for dinner or tickets to a show. This option can also be found on the main menu under a “Find” option. Menus for restaurants, reviews of shows, store items for purchase are all available through the system and provide the user with an easy to use information system.

At the initial time of the purchase, the family is able to put “e-money” on the device so that children or other members of the group are able to go shopping at a store and purchase items with the e-money. A child safety provision would be employed so that the parents could monitor, regulate, prohibit and/or limit a child's spending.

Another feature of the invention is that it can incorporate a digital camera. At the end of the day the digital photos can be transferred onto a disk and taken home as a keepsake for a small fee. This invention remedies the common problems faced in an amusement park thereby optimizing a family's enjoyment. Long waits in an amusement park are a regular occurrence. The invention remedies this problem in a number of ways.

First, an interactive map allows the user to see the real time wait for a particular ride. In addition, the computer can tell the user where there is the shortest wait.

Second, the system allows the user to make a reservation and hold a place in line. This may be used for rides, a table for dinner, ordering food for pickup, and so forth. There are different levels of priority based on the purchase price of the system. The silver level is the least expensive, followed by gold and then followed by platinum, the most exclusive package. The higher the package purchased, the higher priority the family is given. Only a certain number of platinum packages are allotted for purchase. They all distributed on a first come, first serve basis. The purpose of limiting the platinum packages is to keep the priority levels effective.

When a wait in line is unavoidable, the handheld transceiver may be equipped with a variety of games for entertainment. The user enters the network where the user may play interactive games alone or against other users in the park who are identifiable by personal nickname or group nickname. Such games may be games of skill, such as Dungeons and Dragons or may be designed for group pay such as an education term versus team quiz competition. Ordering of food or services ahead of time may also done using the system.

### BRIEF DESCRIPTION OF THE DRAWINGS

FIG. 1 is a schematic diagram of the inventive amusement park;

FIG. 2 is a flowchart illustrating the method of the present invention; and

FIG. 3-14 illustrate transceiver screens during operation of the invention.

### DETAILED DESCRIPTION OF THE DRAWINGS

In accordance with the present invention, a tracking system designed to enhance the safety and enjoyment of families at an amusement park or other recreational facility is provided.

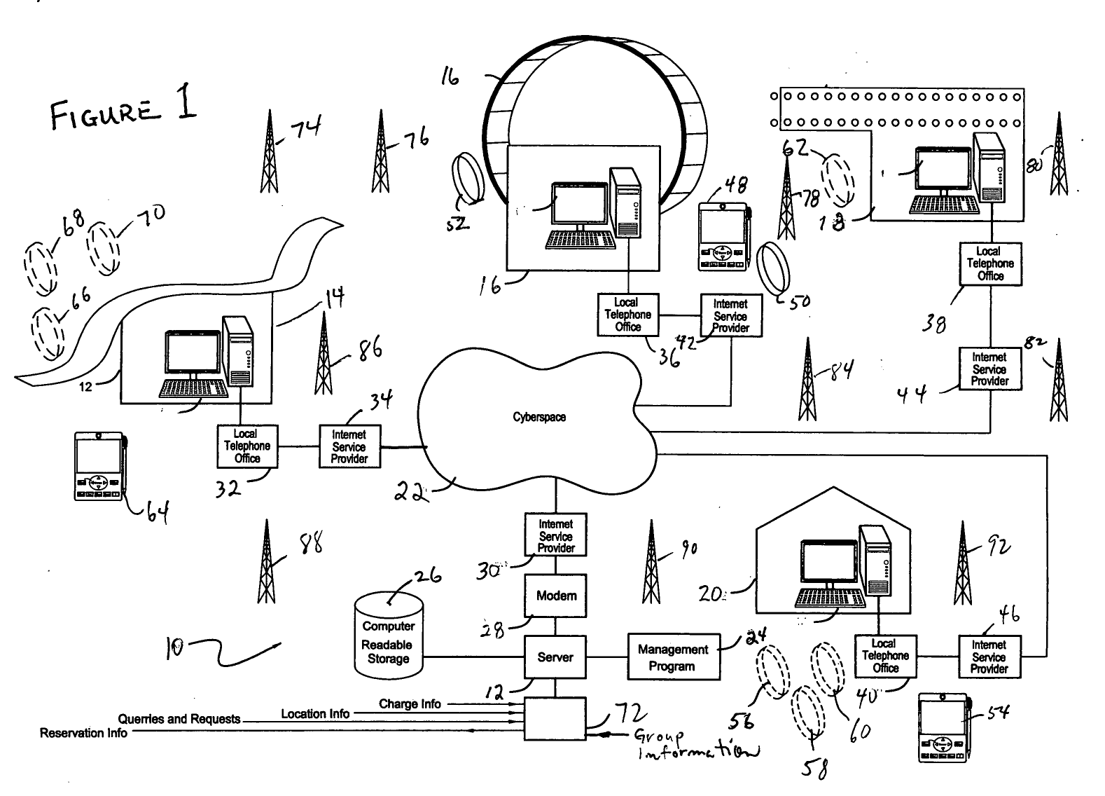

A host system 10 constructed in accordance with the present invention is illustrated in FIG. 1. System 10 comprises a central server 12 which is put in communication with various facilities of the amusement park, such as waterslide 14, Ferris wheel 16 theatre 18 and restaurant 20. Communication may be by any means, such as wireless data transfer, hard wires, dial up internet, Ethernet, or the like. However, given the proliferation of Internet connections in the world, cyberspace 22, (for example, the Internet) is implemented in the illustrated embodiment. Server 12 in controlled by a management software program 24 and maintains information in a database 26. Server 12 communicates in cyberspace 22 through a modem 28 which connects it to an Internet service provider 30 who is, in turn, connected to, for example, the backbone of the Internet.

In similar fashion, waterside attraction office personal computer 14 is connected through the local telephone office 32 to its Internet service provider 34, which, in turn, provides connection to the Internet. Ferris wheel office personal computer 16, theater office personal computer 18 and restaurant office personal computer 20 are connected to the Internet by their local telephone office 36,38 and 40 to their Internet providers 42, 44 and 46, respectively. As will be apparent, waterslide 14, Ferris wheel 16, theatre 18, and restaurant 20 are situated at different locations within the park.

In accordance with one embodiment, groups of patrons are each provided with a transceiver (typically given to an adult or chaperone) and one or more transponder wristbands (typically given to children in the group). In the illustrated example, one group is provided with transceiver 48 and transponders 50 and 52, with the supervising adult wearing a wristband and holding a transceiver. Another group is provided with a transceiver 54 and transponders 56, 58, 60 and 62. It is noted that the child wearing transponder 62 is relatively remote from the other children associated with transceiver 54, being in theater 18. A third group is provided with a transceiver 64 and associated transponder 66, 68 and 70.

In accordance with the preferred embodiment all individuals holding transceivers are also given transponders, so that the transceiver may be moved from one responsible individual to another, for example from a husband to a wife as they share the duties of supervising their family.

As information input board 72 is associated with server 12 and receives information directly from transceivers 48, 54 and 64. A number of transponder readers 74, 76, 78, 80, 82, 84, 86, 88, 90 and 92 are located at various locations throughout the park and inform the locations of transponders, such as transponder 50 and 52 to input board 72. Transponder readers 74-92 are used as location interrogators to determine the location of the transducers and, accordingly, the individuals with whom the transducers are associated because the individuals are wearing the transducers on their wrists.

Optionally, triangulation, using a number of receivers at different locations, may be used to locate transceiver.

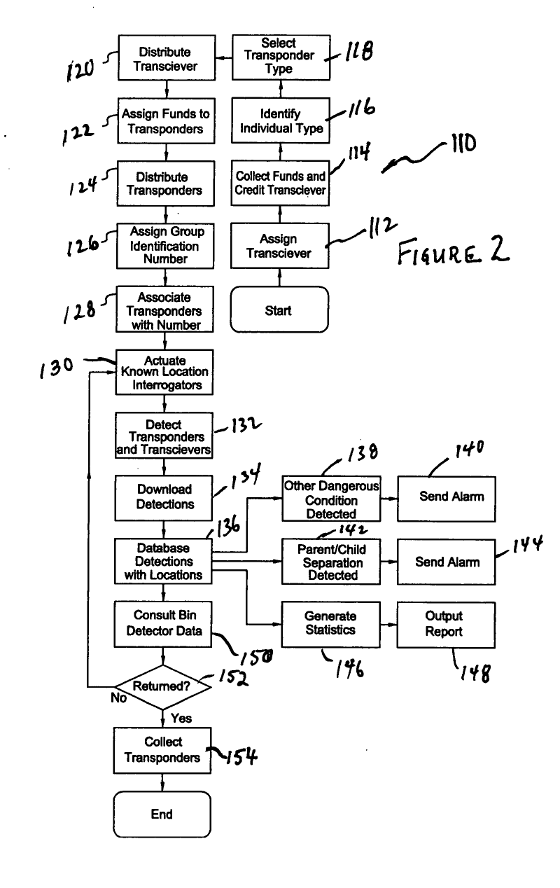

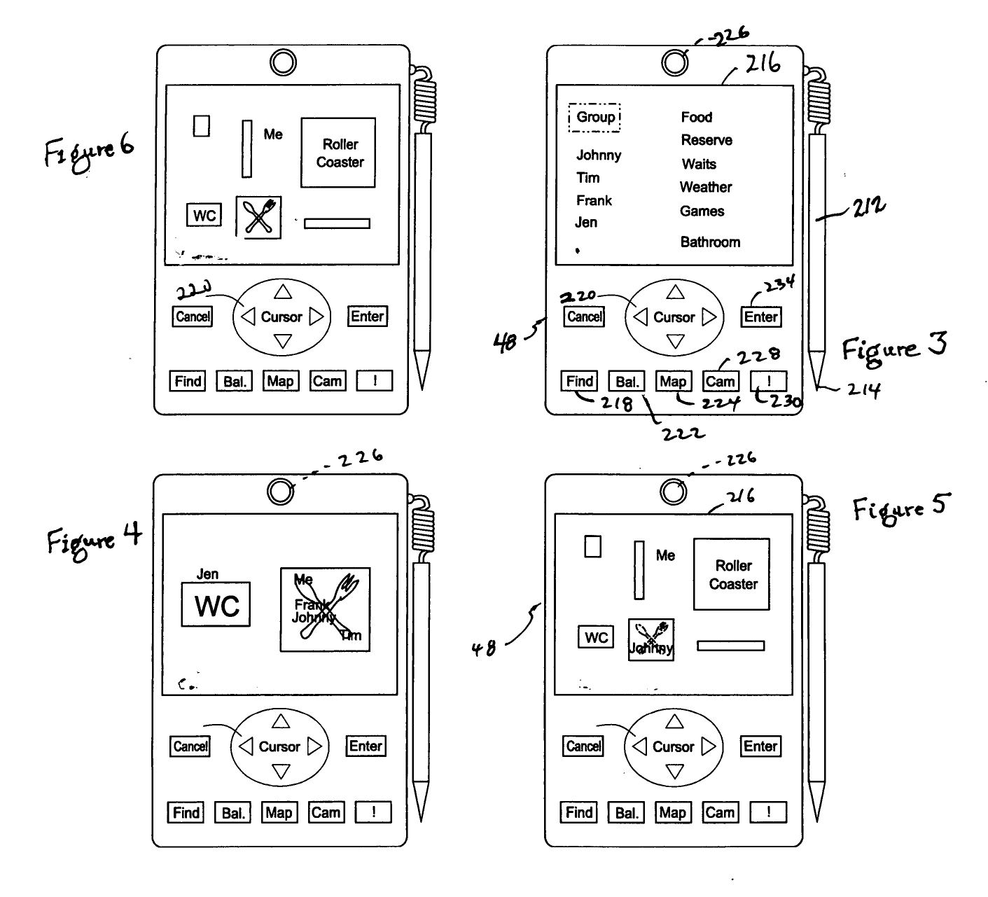

The operation of the system 10 of the present invention may be understood with reference to FIG. 2. When customers come to the amusement park with their children, the group is able to RENT or may be furnished as part of a package with at least one transceiver, such a transceiver 48, at step 112. Such a transceiver 48 is illustrated in detail in FIG. 3, displaying the default screen.

At this point, optionally, the group may be assigned a rating, such as silver, gold or platinum, as discussed above with eligibility for reserved places or priority at rides, attractions, restaurants, theaters and so forth. In accordance with the present invention, it is contemplated that such reserve places will be released in response to 1) certain levels of demand and 2) as a function of time before availability based on objectives of filling all seats.

Next, at step 114, funds are collected from the customer and credited to the transceiver and thus the group associated with the transceiver. At step 116 the persons operating the amusement park identify the various individuals by type, such as by age and sex, and at step 118, they select a transponder particular to the individual type. For example one transponder may be for male children between three and six years old. Another transponder may be for teenage female children between twelve and sixteen years old.

In accordance with the present invention, the transponders are used to determine the location of the individuals. Knowledge of the age and sex of the child or knowledge of the fact that the individual wearing the transponder is an adult be used in an artificial intelligence program associated with central server 12 to assess the appropriateness of the presence of the individual in various locations. The objective is to determine a dangerous condition and prevent the same by alerting the transceiver which has been given to the supervisory adult. Optionally, multiple transceivers may be given to multiple supervisory adults and common warnings sent to all transceivers.

For example, if the system determines that transponders 56, 58 and 60 are in closely associated proximity with transceiver 54, and notes that the only other transponder associated with the system is transponder 62, is associated to a very young child not likdly to be intentionally left in a theater alone, the system will determine that an alert such as an alphanumeric message should be sent to transceiver 54 informing the responsible adult that the child associated with transponder 62 is in the theater. This can be done by name of the transponder wearer is entered in the system when the transponder is given out. For example the screen on the transceiver may read “Warning: Johnny is in the theater and separated from your group by 100 feet. Please push “Cancel” to acknowledge receipt of this message”. This can be done by an audible warning such as a ringing sound or the like.

Additionally, the information respecting the age and sex of the guests and the identification of the attractions which they spend time at and the amount of time that they spend there may be used to improve marketing, control traffic, design additions to the amusement facility or regulate its development, the removal of attractions or other changes.

At step 120 the transceiver is given to the responsible adult. At step 122 funds associated with the transceiver at step 114 may be selectively associated with various transponders. In accordance with the invention it is contemplated that individuals wearing the transponders will use the same to pay for various attractions using funds associated with the particular transponder.

Step 120 for the transponders are distributed to the persons that will wear them. In accordance with the invention, it is contemplated that transponders, such as transponders 50 and 52 will be wristbands, although many other forms may be employed, such as toys, hats, necklaces or cards.

At step 126, each group is given an identification designator which may be a number, or, a nickname, perhaps one selected by the group itself, such as “Brooklyn Rugrats”. The purpose of the name selection is to give a teamidentity in the event of competitive play using the transceiver, as described above. At step 128 the system associates the transponders with the identification designator. The guests are then free to go through the park and visit various attractions, charge rides, food or the like against the funds deposited at step 114, and enjoy the sights. If the group does not have a transceiver, separation of members from the group may be monitored by the inventive system and park employers notifies of dangerous condition.

Transponder readers, such as transponder readers 74-92 are placed throughout the park at numerous locations which are so close to each other that no matter where in the park an individual is, he is either within range of a transponder reader or cannot leave the park without coming into range of a transponder reader. Ideally, the individual is always within the range of a transponder reader, so that his location is positively known at all times.

At step 130, transponder readers are interrogated to determine the location of transponders. The information is determined at step 132 and downloaded at step 134 to allow their storage and evaluation at step 136. This information is sent to server 12. This allows the detection of a dangerous condition at step 138, perhaps sending and alarm at step 140, depending upon the guidelines set forth in the operating program 24. the information is also used to determine separation of a child from a responsible adult at step 142 which can also result in the sending of alarm at step 144 if the system is program to determine that the separation is possibly problematic. In addition, statistics respecting attendance, popularity and so for the may be generated at step 146 and a report output at step 148 at step 150 for the purpose of guiding marketing or park designs.

In accordance with the preferred embodiment of the invention, the system determines whether transceivers and transponders have returned to the area of the office of the operator of the amusement park. If this occurs, the transceiver assignment at step 112 and the transponder assignment of the particular transceiver implemented step 118 are, optionally, removed from the system. Such removal may be made in response to detection of the same in a return bin. If, at step 152, the system via server 12 determines that the transponders and transceivers have been returned, the system in forms the collection of the transponders to the operators at step 154.

As alluded to above, transceivers, such as transceiver 48 may be used to receive alarms, and provide a wide range of functions to the guests at the amusement park. Referring to FIG. 3, for example, each transceiver includes a stylus 212. Stylus 212 has a point 214 which may be used to select and item from the menu provided on screen 216, such as the item “Group” which has been selected in FIG. 3. If “find” button 218 is depressed while “Group” has been selected, the system will produce a map on screen 216, as illustrated in FIG. 4, showing the location of the various members of a party.

Alternatively, entries on the screen may be scanned using cursor button 220. Cursor button 220 may also be sued to zoom in and out of the various maps displayed by the system. Key 222 may be depressed at any time to obtain a display of the balance of money left on the account associated with the particular transceiver, in this case transceiver 48. Facilities may be places throughout the park replenishing the balance in their debit accounts with the park. A map of the park may be displayed by pressing button 224 at any time, and the same may be zoomed in or out using cursor 220. Similarly, a camera function, for a self-contained camera lens 226 on the side of the transceiver 48 opposite display 216, may be activated upon depression of key 228. An emergency condition may be signaled to server 12 using the “!” key 230.

If the “Johnny” entry is screen 216 in FIG. 3 is highlighted and map key a 24 of the “Find” key is depressed, a display showing the location of Johnny and the location of the person assigned to transceiver 48 will be displayed on screen 216 as illustrated in FIG. 5. In similar fashion, if “Bathroom” is highlighted in display 216 in FIG. 3 and the “Find” is depressed the system will produce a map showing the location of a bathroom labeled “WC”, as illustrated in FIG. 6. If the user wished to obtain a slightly larger display which is easier to read, cursor key 220 may be used because the system to display a zoomed in image as illustrated in FIG. 7.

If the user wishes to check the weather, he merely puts point 214 of stylus 212 on the “Weather” entry in display 216, as illustrated in FIG. 3 and a weather report is shown on the screen for a period of time after which, it reverts to the default screen of FIG. 3.

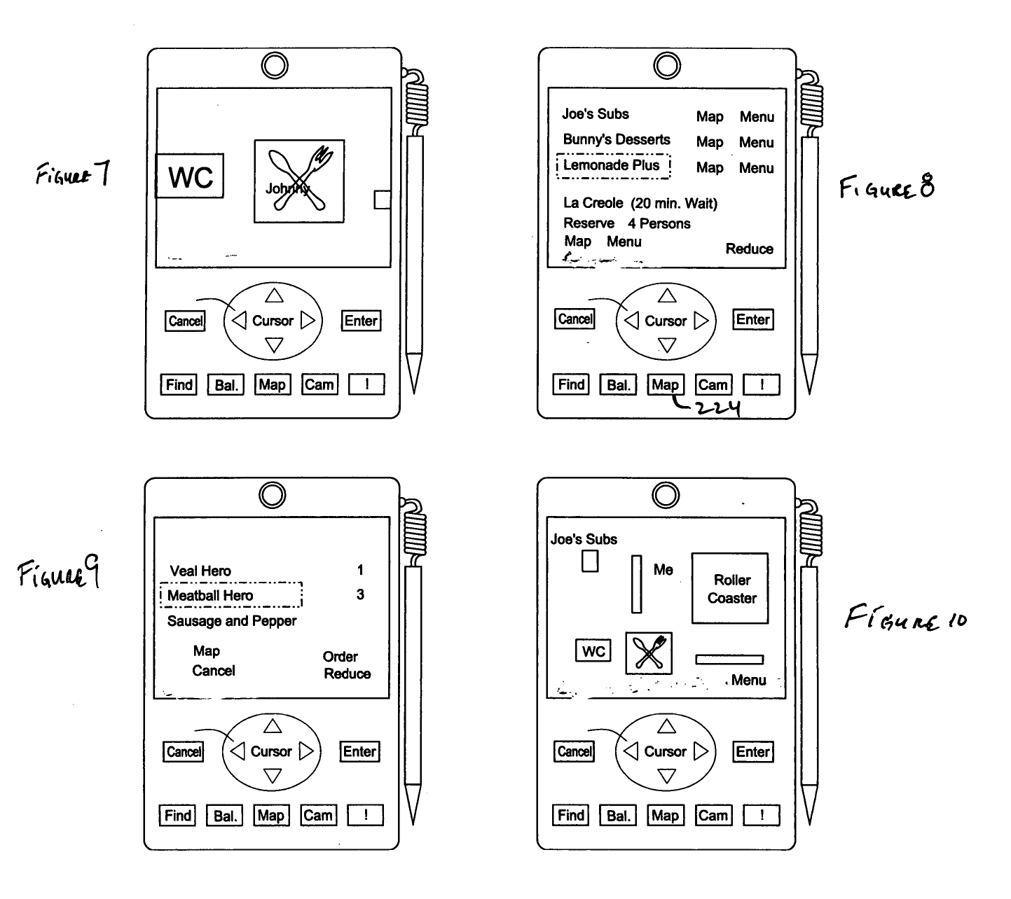

If the “Food” alphanumeric entry in screen 216 is clicked with cursor 212 and enter key 232 depressed, or alternatively the “Food” alphanumeric entry in screen 216 is double clicked, the system proceeds to the display of restaurants illustrated in FIG. 8. The user then can select one of the restaurants in the example of FIG. 8 a restaurant by the name of “Lemonade Plus”. He may then reserve places for four persons by using the stylus to click on the “Reserve” entry four times. If he clicks too may times, a click on the “Reduce” entry will result in the number being reduced once for each click with stylus 212. Efficiency in the restaurant's service may be achieved by the guest clicking on the “Menu” entry. This will result in presentation of the screen image illustrated in FIG. 9. Here, clicking on a particular item will result in ordering the item and Highlighting it. For example, in the instant example, “meatball hero”, has been clicked on three times resulting in highlighting the entry and displaying that three heroes have been ordered. Clicking on the “Reduce” alphanumeric display while “Meatball hero” is highlighted will reduce the number o meatball heroes ordered. When the order has been completed, clicking on the “Order alphanumeric display with stylus 212 results in placing the order and identifying the holder of the receiver to the restaurant to expedite service.

It is noted in accordance with the present invention that communication between the various facilities and the individual is done in the preferred embodiment by the communication originating at, for example, the computer at the office of the facility, passing to the Internet where it is forwarded to the server 212 or vice versa.

In similar fashion, if “Joe's Subs” is highlighted in the screen of FIG. 8 and map key 224 is depressed, a map, such as that illustrated in FIG. 10, showing the location of the individual and the restaurant Joe's Subs is displayed.

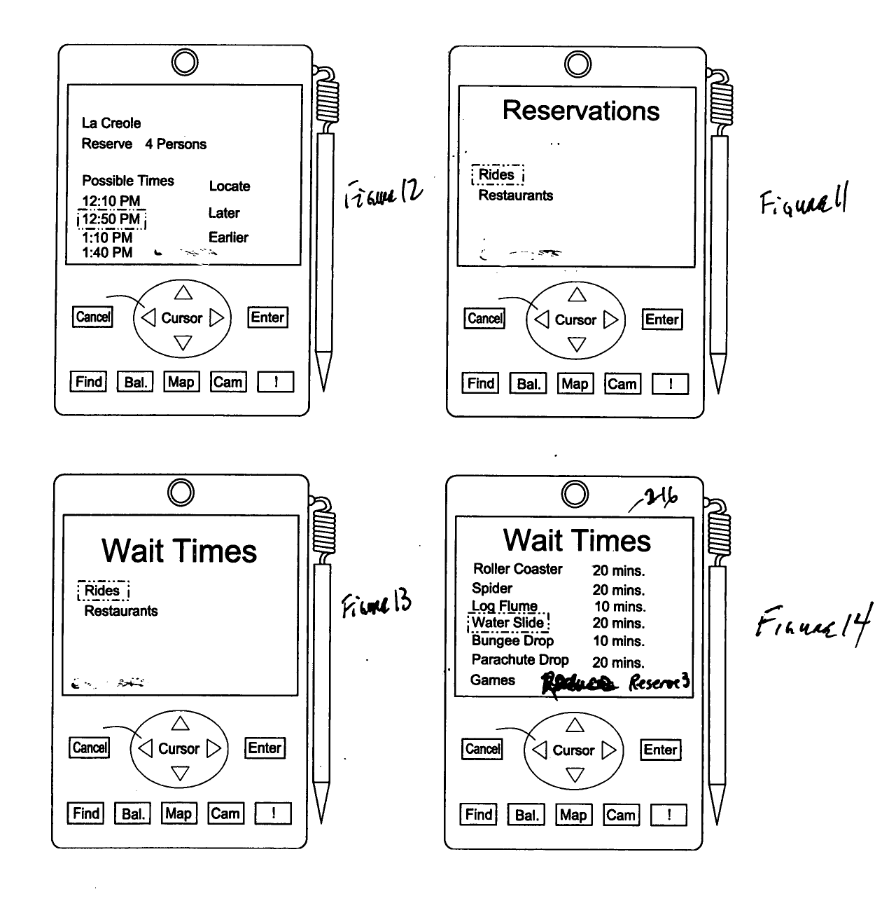

Referring back to FIG. 3, if the “Reserve” alphanumeric display in screen 216 is depressed, by clicking with stylus 212 or highlighting using cursor key 220 and enter key 234, the reservation screen of FIG. 11 is displayed. If the cursor used to double click on restaurants the screen of FIG. 8 will be displayed. Alternatively, if cursor 212 is double clicked on “Reserve” in FIG. 8, the screen of FIG. 12 will be produced showing, for example, in the case where a four person registration has been request, the available reservation times for four persons. These can be selected by, optionally, double clicking, clicking or using the cursor to select and pressing “Enter”.

Referring again back to FIG. 3, if the “Waits” alphanumeric entry is double clicked on using stylus 212, the screen of FIG. 13 will be presented. Double-clicking on the “Rides” alphanumeric display will display the various rides and the various waiting times, as illustrated in FIG. 14. Reservations may be made by clicking on the “Reserve” alphanumeric designation the appropriate number of times (offset by the correcting number of “Reduce” clicks of necessary while the system highlights a particular ride. The reservation may be sent by pushing the “Enter” key 234. The reservation may be confirmed by an appropriate alphanumeric message on screen 216. In connection with this it is noted that all actions implemented by the system 10 acting through server 12 may be confirmed on the screen by a message to the user of the transceiver.

The inventive system may also be used for amusement in the event of persons have to wait on lines. In this case, a selection of games may be presented on the screen for selection by the user. The games may be, for example, video games, or they may be of an educational nature, such a quiz games in which the user may select the subject with which he wished to play. Alternatively, the games may be organized as either competitive video games or competitive quiz games, and so forth with holder of different transceivers, perhaps known or perhaps not known to each other being presented with a munue of potentioal competitors, with the competitors being given the opportunity to select a desired type or specific game and being assigned the game they have slected if thwo sides wish to paly the same game or being assigned an alternative in the event that a single game cannot be decided upon. Alternatively, an alphanumeric pad may be displayed and a particular team identified for a challenge.

If desired, players may choose to challenge other unknown players to particular game, in which case the system may present a schedule of potential competitors or past competitors who will receive an alarm indicating the challenge which they may elect to accept or reject by double-clicking on the appropriate answer in a challenge question which appears in their screen. Fro example a challenge question may be: “Do you wish to engage in a movie trivia quiz with the Brooklyn Rugrats”. Appearing next to the question may be the answers “yes” and “no”. The challenges team then has the option of double-clicking on the “yes” to accept the challenge or “no” to reject the challenge.

1. An amusement park, comprising:
(a)
(g) a wireless transceiver associated with said guest account designator for a plurality of attraction facilities;
(b) a central computer;
(c) a plurality of attraction facility computers, each of said attraction facility computers being associated with one of said attraction facilities;
(d) a plurality of communication channels coupling information in two directions between said central computer and said plurality of attraction facility computers;
(e) an input device for receiving information indicating the number of persons in a group entering the amusement park and for assigning a guest account designator to each said group, and for assigning an individual guest identification designator;
(f) a detectable marker unit adapted to be physically associated with each guest and encoded with said guest's guest account designator; and communicating with said central computer to send and receive information.

2. An amusement park as in claim 1, further comprising;
(h) a charge card terminal or other cash crediting device for crediting an amount of money to said guest account designator; and
(i) a cash debiting device responsive to said detectable marker unit associated with a particular attraction facility for debiting dollar amounts associated with a said particular attraction facility.

3. An amusement park as in claim 1, wherein said detectable marker is a wrist band.

4. An amusement park as in claim 1, wherein said information received by said wireless transceiver relates to facility operations, the facility operations information being coupled by said attraction facility computers to said central computer.

5. An amusement park as in claim 1, wherein said detectable marker unit is associated with the characteristics of a guest.

6. An amusement park as in claim 1, further comprising:
(h) a grid of location detectors responsive to the proximity of said detectable marker units to determine the location of the individual guest associated with each detectable marker unit; and
(i) a transmitter coupled to receive the output of said location detectors and transmit detection of guests to said central computer.

7. An amusement park as in claim 6, wherein said server is responsive to guest location information received from said transmitter to determine the likelihood of a dangerous condition, said server being responsive to the detection of and elevated likelihood of a dangerous condition to communicate an alarm to said transceiver, said transceiver including an indicator device to signal set alarm.

8. An amusement park as in claim 7, wherein said indicator device is an audible alarm.

9. An amusement park as in claim 6, wherein said transceiver includes a display for sending and receiving messages and for displaying a map of said amusement park indicating the locations of people in the group associated with said transceiver and/or facilities which may be visited by people in said group.

10. An amusement park as in claim 1, wherein said transceiver is program with interactive games.

11. An amusement park as in claim 10, wherein said interactive games are games between participants holding their own transceivers.

12. An amusement park as in claim 1, further comprising:
(h) a charge card terminal or other cash crediting device for crediting an amount of money to said guest account designator;
(i) a cash debiting device responsive to said detectable marker unit associated with a particular attraction facility for debiting dollar amounts associated with said particular attraction facility;
(j) a grid of location detectors responsive to the proximity of said detectable a marker units to determine the location for the individual guest associated with each detectable market unit; and
(k) a transmitter coupled to receive the output of said location detectors and transmit detection of guests to said central computer.

13. An amusement park as in claim 12, wherein said detectable marker is a wrist band, said information received by said wireless transceiver relates to facility operations, the facility operations information being coupled by said attraction facility computers to said central computer, said detectable marker unit is associated with the characteristics of a guest, said server is responsive to guest location information received from said transmitter to determine the likelihood of a dangerous condition, said server being responsive to the detection of an elevated likelihood of a dangerous condition to communicate and alarm to said transceiver, said transceiver including an indicator device to signal set alarm, said indicator device being and audible alarm, said transceiver includes a display for sending and receiving messages and for displaying a map of said amusement park indicating the location of people in the group associated with said transceiver and/or facilities which may be visited by people in said group, and said transceiver is programmed with interactive games.

14. An amusement park as in claim 1, wherein said central server is a virtual set of connections between computing devices located at said attraction facility computers.

15. A method of hosting a guest at an amusement park, comprising:
(a) receiving a group of guests;
(b) assigning a transceiver device to said group of guests;
(c) collecting funds from said group of guests;
(d) identifying individual guests;
(e) associated each individual guests with an individual transponder in accordance with guest characteristics;
(f) assigning said funds among the transponder is associated with said transceiver device;
(g) periodically checking location of individual guests by monitoring transponder detectors;
(h) determining the existence of an elevated likelihood of a dangerous condition;
(i) sending an alarm in response to the detection of an elevated likelihood of a dangerous condition to the associated transceiver; and
(j) charging funds against a particular transponder in response to the use of a facility associated with said amusement park.

16. A method hosting a guest in an amusement park as in claim 15, further comprising:
(k) collecting an essential server information respecting a plurality of facilities in said amusement park:
(l) transmitting said information to said transceiver; and
(m) sending reservation and for purchase information to said facilities to said transceivers.
